(19) United States
(12) Patent Application Publication
(10) Pub. No.: US 2026/0243614 A1
(43) Pub. Date: Aug. 20, 2026

(54) SENSOR APPARATUS, ROBOTIC APPARATUS, AND ELECTRONIC APPARATUS

(71) Applicant: SONY GROUP CORPORATION, TOKYO (JP)

(72) Inventors: KEI TSUKAMOTO, TOKYO (JP); KEN KOBAYASHI, TOKYO (JP); YOSHIAKI SAKAKURA, TOKYO (JP)

(21) Appl. No.: 19/471,276

(22) PCT Filed: Mar. 18, 2024
(86) PCT No.: PCT/JP2024/010427

§ 371 Date: Sep. 30, 2025

(30) Foreign Application Priority Data
Apr. 24, 2023 (JP) 2023-071063

(51) Int. Cl. G01L 1/14; B25J 19/02; G01L 5/00

(52) U.S. Cl. CPC G01L 1/146; B25J 19/02; G01L 5/009

(57) ABSTRACT

A sensor apparatus according to an embodiment of the present technology includes a sensor section and a surface layer. The sensor section is configured to be capable of detecting a pressure distribution. The surface layer is arranged on the sensor section, and includes an internal layer portion and an external layer portion. The internal layer portion is arranged on the pressure detection surface, and is made of a flexible material. The external layer portion covers the internal layer portion, and is made of a deformable material that has a higher elastic modulus than the material of the internal layer portion.

### TECHNICAL FIELD

The present technology relates to a sensor apparatus that can detect a pressure distribution, as well as a robotic apparatus and an electronic apparatus that each include the sensor apparatus.

### BACKGROUND ART

In recent years, automation of work using a robot has been discussed in various scenes with reduction in working population. In order to control a behavior of a robot hand with a high degree of accuracy, there is a need to detect a distribution of pressure that acts on a grasping surface of the robot hand without damaging a grasped object.

For example, Patent Literature 1 discloses a grasping casing of a robot, the grasping casing including a tactile sensor, an internal skin that covers the tactile sensor, and an external skin that is in close contact with the outside of the internal skin, the external skin being softer than the internal skin and having a high coefficient of friction.

### CITATION LIST

### Patent Literature

Patent Literature 1: Japanese Patent Application Laid-open No. 4-57695

### DISCLOSURE OF INVENTION

### Technical Problem

However, the technology disclosed in Patent Literature 1 easily causes a permanent set since the external skin is softer than the internal skin and formed using a material having a high coefficient of friction. This results in a low durability for repeated use and also results in sensor characteristics being affected.

In view of the circumstances described above, it is an object of the present technology to provide a sensor apparatus, a robot hand, and an electronic apparatus that make it possible to improve the durability while securing an accuracy in detecting a stress distribution.

### Solution to Problem

A sensor apparatus according to an embodiment of the present technology includes a sensor section and a surface layer.

The sensor section is configured to be capable of detecting a pressure distribution.

The surface layer is arranged on the sensor section, and includes an internal layer portion and an external layer portion. The internal layer portion is arranged on the pressure detection surface, and is made of a flexible material. The external layer portion covers the internal layer portion, and is made of a deformable material that has a higher elastic modulus than the material of the internal layer portion.

The sensor apparatus makes it possible to improve the durability while securing an accuracy in detecting a stress distribution, since the external layer portion is made of a material having a higher elastic modulus than the material of the internal layer portion.

The sensor section may include a sensor electrode layer that includes a plurality of capacitive elements arranged in a matrix, and a deformation layer that is deformable to support the sensor electrode layer, the deformation layer being made of a material that has a lower elastic modulus than the material of the internal layer portion.

The surface layer may further include an intermediate layer portion that is arranged between the internal layer portion and the external layer portion, the intermediate layer portion being made of a material that has a higher elastic modulus than the material of the external layer portion.

The surface layer may have a stacking structure in which the internal layer portion and the external layer portion are stacked alternately.

The internal layer portion may have a trapezoidal cross section parallel to a thickness direction of the internal layer portion.

The internal layer portion may be made of a flowable material or a rubber material.

The external layer portion may be made of a rubber material or an elastomer material.

The sensor section may further include a reference electrode layer that is connected to a reference potential, and the deformation layer may be arranged between the sensor electrode layer and the reference electrode layer.

The sensor section may include a pair of pressure sensors each including the sensor electrode layer, the deformation layer, and the reference electrode layer, and an isolation layer that is arranged between pressure sensors of the pair of pressure sensors, the isolation layer being made of a viscoelastic material.

A robotic apparatus according to an embodiment of the present technology includes a hand portion that includes a plurality of finger portions respectively including grasping surfaces with which a piece of work is graspable, and sensor apparatuses that are respectively provided to the grasping surfaces.

The sensor apparatus includes a sensor section and a surface layer. The sensor section is configured to be capable of detecting a distribution of pressure acting on the grasping surface. The surface layer includes an internal layer portion that is arranged on the pressure detection surface, the internal layer portion being made of a flexible material; and an external layer portion that covers the internal layer portion, the external layer portion being made of a material that has a higher elastic modulus than the material of the internal layer portion.

An electronic apparatus according to an embodiment of the present technology includes an input operation surface; and a sensor apparatus that is provided to the input operation surface.

The sensor apparatus includes a sensor section and a surface layer. The sensor section is configured to be capable of detecting a distribution of pressure acting on the input operation surface. The surface layer includes an internal layer portion that is arranged on the pressure detection surface, the internal layer portion being made of a flexible material; and an external layer portion that covers the internal layer portion, the external layer portion being made of a material that has a higher elastic modulus than the material of the internal layer portion.

### BRIEF DESCRIPTION OF DRAWINGS

FIG. 1 is a perspective view of a primary portion of a robotic apparatus that includes a sensor apparatus according to an embodiment of the present technology.

FIG. 2 is a schematic cross-sectional side view illustrating a structure of a cross section of a sensor sheet that is a configuration example of the sensor apparatus.

FIG. 3 is a schematic plan view of a sensor electrode layer of the sensor sheet.

FIG. 4 is a plan view of a primary portion of a configuration example of a sensing section of the sensor apparatus.

FIG. 5 is a schematic cross-sectional side view illustrating a structure of a cross section of a sensor sheet that is another configuration example of the sensor apparatus.

FIG. 6 is a block diagram of a configuration of a control unit.

FIG. 7 is a schematic cross-sectional side view of a sensor apparatus according to a second embodiment of the present technology.

FIG. 8 is a schematic cross-sectional side view of a sensor apparatus according to a third embodiment of the present technology.

FIG. 9 schematically illustrates a configuration of a sensor apparatus according to a fourth embodiment of the present technology.

FIG. 10 is a set of schematic plan views illustrating examples of a shape of an upper surface of an internal layer portion.

FIG. 11 is a schematic cross-sectional side view of a modification of a configuration of a surface layer included in the above-described sensor apparatus.

FIG. 12 is a schematic cross-sectional side view of a modification of the configuration of the surface layer included in the above-described sensor apparatus.

FIG. 13 is a set of cross-sectional views of structures of surface layers used in experimental examples of the present technology.

FIG. 14 is a diagram used to describe measurement of stiffnesses of the surface layers in a thickness direction in the experimental examples.

FIG. 15 is a diagram used to describe measurement of stiffnesses of the surface layers in a shearing direction in the experimental examples.

FIG. 16 is a perspective view of an electronic apparatus that is used to describe another embodiment of the present technology.

FIG. 17 is a cross-sectional side view of a modification of the configuration of the sensor apparatus.

FIG. 18 is a diagram used to describe an effect of another modification of the configuration of the sensor apparatus.

### MODE(S) FOR CARRYING OUT THE INVENTION

Embodiments according to the present technology will now be described below with reference to the drawings.

### First Embodiment

### [Robotic Apparatus]

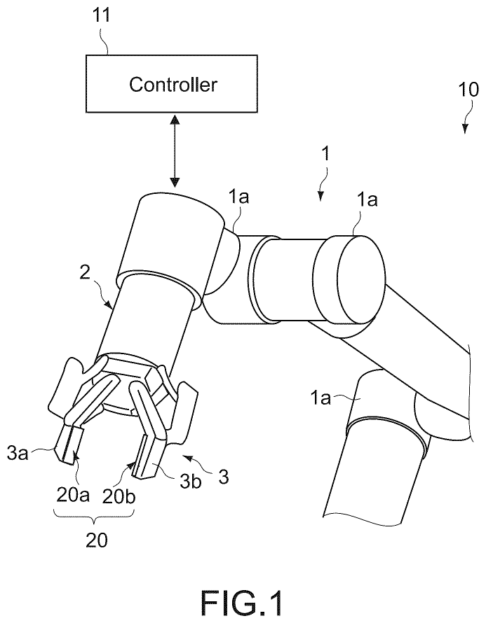

FIG. 1 is a perspective view of a primary portion of a robotic apparatus 10 that includes a sensor apparatus 20 according to an embodiment of the present technology. As illustrated in FIG. 1, the robotic apparatus 10 includes an arm portion 1, a wrist portion 2, and a hand portion 3.

The arm portion 1 includes joint portions 1a, and the hand portion 3 can be moved to any position by the joint portions 1a being driven. The wrist portion 2 is rotatably connected to the arm portion 1, and the hand portion 3 can be rotated by the rotation of the wrist portion 2.

The hand portion 3 includes two finger portions 3a and 3b that face each other, and a target object can be grasped between the two finger portions 3a and 3b by the two finger portions 3a and 3b being driven. Note that the hand portion 3 includes two fingers in the example illustrated in FIG. 1. However, the number of finger portions can be changed as appropriate, such as three, or four or more.

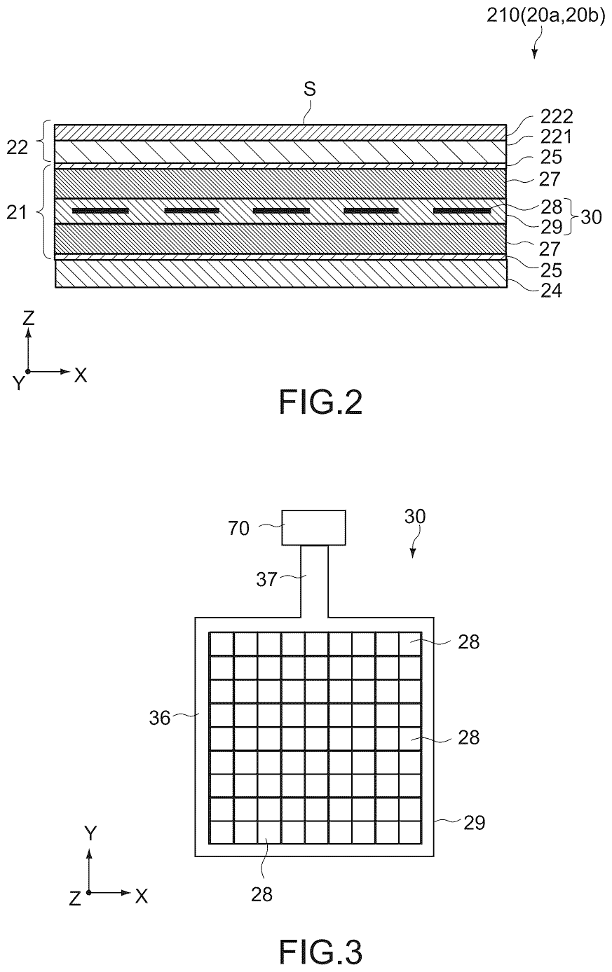

Sensor apparatuses 20a and 20b (hereinafter also collectively referred to as the sensor apparatuses 20) are respectively provided to facing surfaces (grasping surfaces) of the two finger portions 3a and 3b. The sensor apparatus 20 includes a pressure detection surface, and can detect a force applied to the pressure detection surface in the vertical direction (a Z-axis direction). Further, the sensor apparatus 20 can detect a force applied in an in-plane direction of the pressure detection surface (an X-axis direction and a Y-axis direction). In other words, the sensor apparatus 20 is a three-axis sensor that can detect forces corresponding to directions of three axes. Note that a configuration of the sensor apparatus 20 will be described later with reference to, for example, FIG. 2.

The robotic apparatus 10 is driven by control being performed by a controller 11. The controller 11 includes, for example, a control section and a storage. The control section is, for example, a central processing unit (CPU), and controls driving of each structural element of the robotic apparatus 10 on the basis of a program stored in the storage. The controller 11 may be a dedicated apparatus of the robotic apparatus 10 or a general-purpose apparatus. The controller 11 may be, for example, a personal computer (PC) connected to the robotic apparatus 10 by wire or wirelessly, or a server apparatus in a network. The controller 11 may be a portion of the robotic apparatus 10.

### [Sensor Apparatus]

Subsequently, the sensor apparatus 20 (20a, 20b) is described in detail. The sensor apparatuses 20 have the same configuration. As described above, the sensor apparatus 20 is a sensor sheet that can detect a distribution of pressure acting on the pressure detection surface.

### First Configuration Example

FIG. 2 is a schematic cross-sectional side view illustrating a structure of a cross section of a sensor sheet 210 that is a configuration example of the sensor apparatus 20. FIG. 3 is a schematic plan view of a sensor electrode layer 30 of the sensor sheet 210.

In FIGS. 2 and 3, the X-axis direction and the Y-axis direction are directions parallel to a pressure detection surface S of the sensor sheet 210 (hereinafter also referred to as the in-plane direction), and the Z-axis direction is a direction vertical to the pressure detection surface S (hereinafter also referred to as the vertical direction). Further, an upper portion in FIG. 2 corresponds to a front side on which an external force is applied, and a lower portion in FIG. 2 corresponds to a rear side that is situated opposite to the front side.

The entirety of the sensor sheet 210 has a shape of a rectangular flat plate in a plan view. Note that it is sufficient if the shape of the sensor sheet 210 in the plan view is set as appropriate according to a shape of a portion in which the sensor apparatus 20 is arranged, and the shape of the sensor sheet 210 in the plan view is not particularly limited. For example, the shape of the sensor sheet 210 in the plan view may be a polygon other than a rectangle, a circle, or an ellipse.

As illustrated in FIG. 2, the sensor sheet 210 includes a laminate that includes a pressure sensor 21 that serves as a sensor section, a surface layer 22 that is arranged on an upper surface of the pressure sensor 21, and a support layer 24 that is arranged on a lower surface of the pressure sensor 21.

The pressure sensor 21 includes a sensor electrode layer 30, paired reference electrode layers 25 that face each other in the Z-axis direction such that the sensor electrode layer 30 is situated between the paired reference electrode layers 25, and deformation layers 27 that are each arranged between the sensor electrode layer 30 and a corresponding one of the reference electrode layers 25.

The sensor electrode layer 30 includes, for example, a flexible printed circuit. As illustrated in FIG. 3, the sensor electrode layer 30 includes a body portion 36 that is rectangular in a plan view, and an extension 37 that extends outward from the body portion 36. Note that the shape of the sensor electrode layer 30 in the plan view is not limited to a rectangle, and can be changed as appropriate.

The sensor electrode layer 30 includes a flexible base material 29 and a plurality of sensing sections 28 provided to the surface of the base material 29 or in the base material 29. For example, a polymer resin such as polyethylene terephthalate, polyimide, polycarbonate, or an acrylic resin is used as a material of the base material 29. The sensing sections 28 are regularly arranged in a matrix with specified spacing in directions of length and width (length: the Y-axis direction, width: the X-axis direction). In the example illustrated in FIG. 3, the number of sensing sections 28 is 81 in total with nine×nine (length×width). Note that the number of sensing sections 28 can be changed as appropriate.

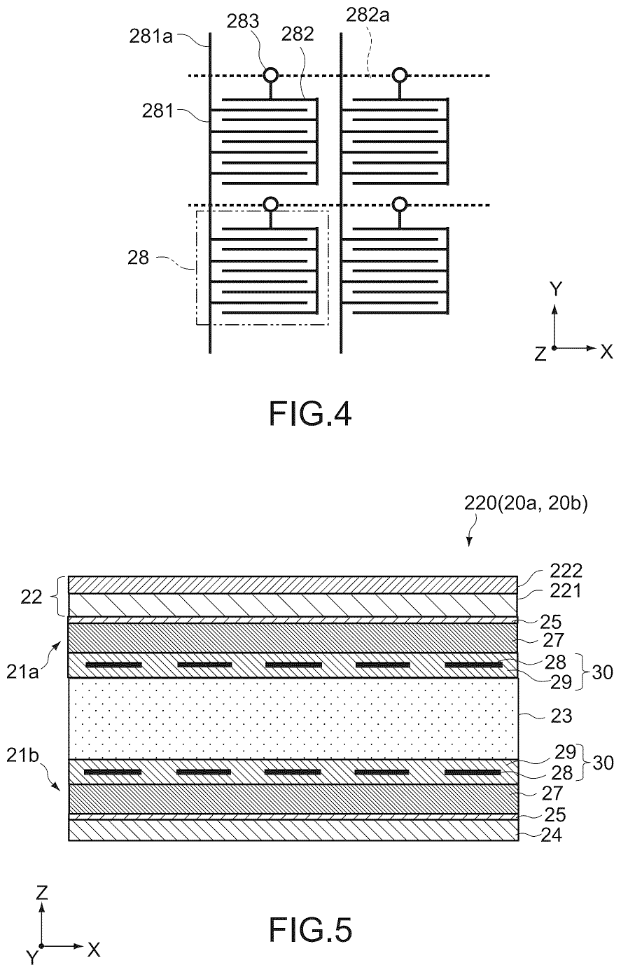

The sensing section 28 includes a plurality of capacitive elements (detection elements) capable of detecting a change in a distance to the reference electrode layer 25 as a change in capacitance. As illustrated in, for example, FIG. 4, the sensing section 28 includes a pulse electrode 281 in the form of comb teeth and a sense electrode 282 in the form of comb teeth. The pulse electrode 281 in the form of comb teeth and the sense electrode 282 in the form of comb teeth are arranged such that the comb teeth of the pulse electrode 281 and the comb teeth of the sense electrode 282 face each other, and each sensing section 28 includes a region (a node region) in which the comb teeth of one of the pulse electrode 281 and the sense electrode 282 are each placed in a corresponding one of spaces each formed between the comb teeth of another of the pulse electrode 281 and the sense electrode 282. Each pulse electrode 281 is connected to wiring 281a that extends in the Y-axis direction, and each sense electrode 281 is connected to wiring 282a that extends in the X-axis direction. The wiring 281a is arranged on a front surface of the base material 29 in the X-axis direction, and the wiring 282a is arranged on a back surface of the base material 29 in the Y-axis direction. Each sense electrode 282 is electrically connected to the wiring 282a through a through-hole 283 provided to the base material 29. The sensor electrode layer 30 may include a ground line. The ground line is provided to, for example, an outer peripheral portion of the sensor electrode layer 30, or a portion in which the wiring 281a and the wiring 282a are placed side by side.

Note that a structure of the sensing portion 28 is not particularly limited to the example described above, and any structure may be adopted. For example, the sensor electrode layer 30 may be a laminate that includes a first electrode sheet that has a first electrode pattern in the form of a grid, and a second electrode sheet that has a second electrode pattern in the form of a grid, the first electrode pattern extending in the X-axis direction, the second electrode pattern extending in the Y-axis direction. In this case, the sensing section 28 is formed at an intersection of the first electrode pattern and the second electrode pattern.

The reference electrode layer 25 is connected to a reference potential. In the present embodiment, the reference electrode layer 25 is a so-called ground electrode, and is connected to a ground potential. The reference electrode layer 25 is flexible, and has a thickness of, for example, from about 0.05 mm to about 0.5 mm. For example, an inorganic conductive material, an organic conductive material, or a conductive material containing both the inorganic conductive material and the organic conductive material is used as a material of the reference electrode layer 25.

Examples of the inorganic conductive material include metals such as aluminum, copper, and silver; alloys such as stainless steel; and metal oxides such as zinc oxide and indium oxide. Further, examples of the organic conductive material include carbon materials such as carbon black and a carbon fiber, and conductive polymers such as substituted or unsubstituted polyaniline and polypyrrole. The reference electrode layer 25 may be made out of, for example, a thin plate made of metal such as stainless steel or aluminum; a conductive fiber; or a conductive nonwoven fabric. The reference electrode layer 25 may be formed on a plastic film by, for example, vapor deposition, sputtering, bonding, or coating.

The deformation layer 27 is arranged between the sensor electrode layer 30 and the reference electrode layer 25. The deformation layer 27 has a thickness of, for example, from about 100 μm to about 1000 μm. The deformation layer 27 is elastically deformable in response to an external force. When an external force is vertically applied to the sensor sheet 210, the deformation layer 27 is elastically deformed in response to the external force, and the reference electrode layer 25 gets closer to the sensor electrode layer 30. Here, there is a change in capacitance between the pulse electrode 281 and the sense electrode 282 in the sensing section 28. This enables the sensing section 28 to detect this change in capacitance as a pressure value.

For example, the deformation layer 27 has a thickness greater than 100 μm, and equal to or less than 1000 μm. A basis weight of the deformation layer 27 is, for example, 50 mg/cm² or less. When the thickness and the basis weight of the deformation layer 27 are respectively set in these ranges, this makes it possible to improve a detection sensitivity of the pressure sensor 22 in the vertical direction.

A lower limit of the thickness of the deformation layer 27 is not particularly limited if the lower limit is greater than 100 μm, and the lower limit may be, for example, 150 μm or greater, 200 μm or greater, 250 μm or greater, or 300 μm or greater. Further, an upper limit of the thickness of the deformation layer 27 is not particularly limited if the upper limit is equal to or less than 1000 μm, and the upper limit may be, for example, 950 μm or greater, 900 μm or less, 850 μm or less, or 800 or less.

In order to be easily deformed in the Z-axis direction, the deformation layer 27 may include, for example, a patterning structure including a column structure. Various structures such as a matrix structure, a stripe structure, a mesh structure, a radial structure, a geometric structure, and a spiral structure may be adopted as the patterning structures.

The surface layer 22 is formed as a contact surface that is brought into contact with a piece of work when the robotic apparatus 10 grasps the piece of work with the finger portions 3a and 3b. The surface layer 22 includes an internal layer portion 221 and an external layer portion 222.

The internal layer portion 221 is arranged on the sensor section and made of a flexible material. Examples of the flexible material include a flowable material such as gel and a relatively less stiff rubber material such as silicone rubber. Particularly in the present embodiment, the internal layer portion 221 is made of a material having a higher elastic modulus (the Young's modulus) than a material of the deformation layer 27 (for example, 100 kPa or less). In the present embodiment, the elastic modulus of the internal layer portion 221 is about 30 kPa, and the elastic modulus of the deformation layer 27 is about 5 kPa.

The external layer portion 222 covers the internal layer portion 221, and is made of a deformable material having a higher elastic modulus than the material of the internal layer portion 221. The external layer portion 222 includes a function to transmit, to the internal layer portion 221, pressure that acts on the pressure detection surface S by primarily stretching in the in-plane direction. Typically, the external layer portion 222 is formed into a sheet or film having a smaller thickness than the internal layer portion 221. The elastic modulus of the external layer portion 222 is, for example, 1 MPa or greater, and specifically, the external layer portion 222 is made of any material such as a relatively stiff rubber material including acrylic rubber, a synthetic resin material including elastomer, woven fabric, nonwoven fabric, or leather. The surface of the external layer portion 222 serves as the pressure detection surface S receiving load (a reaction force of a grasping force) imposed by a piece of work during grasping operation. Note that the external layer portion 222 favorably has a surface texture that makes it possible to obtain a specified friction or greater with a piece of work, in order to stably grasp the piece of work.

The internal layer portion 221 and the external layer portion 222 are attached closely at their interface using, for example, an adhesive. Thus, when stress on the surface layer 22 is released, a distortion in the internal layer portion 221 is eliminated concurrently with return of an elasticity of the external layer portion 222. This results in enhancing the conformability to a temporal change in a distribution of stress acting on the surface layer 22. Further, the external layer portion 222 serves as a protection layer for the internal layer portion 221, and this makes it possible to improve a durability of the internal layer portion 221.

A thickness of the external layer portion 222 is not particularly limited, and typically, the external layer portion 222 is formed to have a smaller thickness than the internal layer portion 221. For example, the external layer portion 222 may have a thickness that is less than or equal to half the thickness of the internal layer portion 221. In the present embodiment, the internal layer portion 221 has a thickness of 1 mm, and the external layer portion 222 has a thickness of 0.5 mm.

The support layer 24 supports the pressure sensor 21, and serves as, for example, a joint layer used to fix the pressure sensor 21 to the surface (the grasping surface) of the finger portion 3a, 3b. The support layer 24 includes, for example, a viscous layer such as a double-sided tape.

A control unit 70 that calculates a force in the in-plane direction on the basis of information regarding pressure detected by the pressure sensor 21 is mounted on the extension 37 of the sensor electrode layer 30. The control unit 70 is typically a computer that includes a central processing unit (CPU), and includes an integrated circuit such as an IC chip. The control unit 70 is mounted on the sensor electrode layer 30 (the extension 37), and is configured such that the control unit 70 drives the pressure sensor 21 and such that an output signal from the pressure sensor 21 is input to the control unit 70. Note that the control unit 70 is not limited to the example in which the control unit 70 is mounted on the sensor electrode layer 30.

### Second Configuration Example

FIG. 5 is a schematic cross-sectional side view illustrating a structure of a cross section of a sensor sheet 220 that is another configuration example of the sensor apparatus 20. Note that a portion corresponding to that in the first configuration example is denoted by the same reference numeral as the first configuration example, and a detailed description thereof is omitted.

The sensor sheet 220 includes a first pressure sensor 21a on the front side (a side of a piece of work), a second pressure sensor 21b on the rear side (a side of the finger portion 3a, 3b), and an isolation layer 23 that is arranged between the first pressure sensor 21a and the second pressure sensor 21b, where the first pressure sensor 21a and the second pressure sensor 21b each serve as a sensor section. In other words, the sensor sheet 220 has a structure in which the second pressure sensor 21b, the isolation layer 23, and the first pressure sensor 21a are stacked vertically in this order from the lower layer of the sensor sheet 220. The first pressure sensor 21a and the second pressure sensor 21b each have a configuration similar to or substantially similar to the configuration of the pressure sensor 21 described above. Thus, descriptions thereof are omitted.

The sensor sheet 220 detects a force (a shearing force Fs) applied to the sensor sheet 220 in the in-plane direction, on the basis of a pressure center position, in the in-plane direction, at which a pressure center is detected (a pressure detection position, in the in-plane direction, at which pressure is detected) by the first pressure sensor 21a, and on the basis of a pressure center position, in the in-plane direction, at which a pressure center is detected (a pressure detection position, in the in-plane direction, at which pressure is detected) by the second pressure sensor 21b. Further, the sensor sheet 220 detects a force (a load Fz) applied to the sensor sheet 220 vertically from an upper side on the basis of a value of pressure detected by the first pressure sensor 21a.

The separation layer 23 is fixed between the first pressure sensor 21a and the second pressure sensor 21b through bonding layers (not illustrated). The separation layer 23 is made of a viscoelastic material that is deformed by a load applied to the first pressure sensor 21a through the surface layer 22 and a viscoelastic body layer 81. Examples of this kind of viscoelastic material include a silicone gel, a urethane gel, synthetic rubber, and foam. The isolation layer 23 has a higher elastic modulus than the deformation layer 27, and, for example, the isolation layer 23 has an elastic modulus (100 kPa or less) equivalent to the elastic modulus of the internal layer portion 221 included in the surface layer 22. A thickness of the separation layer 23 is not particularly limited, and is, for example, between 1000 μm and 5000 μm, inclusive. The thickness of the separation layer 23 is set according to, for example, a thickness of the viscoelastic body layer 81. A planar shape of the separation layer 23 is not particularly limited, and is typically a rectangle or a circle.

The sensor sheet 220 further includes the surface layer 22 arranged on the pressure sensor 21. The surface layer 22 has a configuration similar to the configuration of the surface layer 22 in the first configuration example. Thus, a description thereof is omitted.

### [Control Apparatus]

The control unit 70 includes, for example, a control section and a storage. The control section is, for example, a central processing unit (CPU), and controls driving of each structural element of the hand portion 3 by executing a program stored in the storage, on the basis of a control instruction given by the controller 11. Typically, the control unit 70 acquires information regarding forces in directions of three axes that are detected by the sensor apparatus 20, and controls driving of the hand portion 3 on the basis of the information regarding the forces, such that the hand portion 3 stably grasps a target object with an appropriate grasping force.

In the present embodiment, the control unit 70 is a control apparatus that detects a distribution of pressure acting on the grasping surface (the pressure detection surface S), on the basis of output from the sensor apparatus 20, and that issues a control instruction used to change a relative position of the hand portion 3 relative to a piece of work.

The storage includes a nonvolatile memory that stores therein various programs and data that are necessary for processing performed by the control section, and a volatile memory used as a working region for the control section. The various programs may be read from a portable recording medium such as a semiconductor memory, or may be downloaded from a server apparatus in a network.

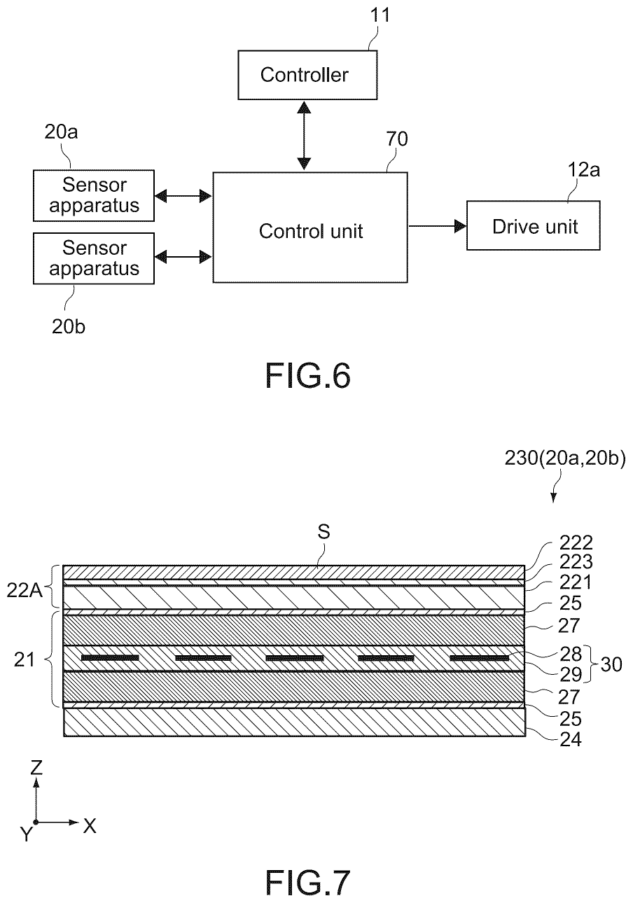

FIG. 6 is a block diagram of a configuration of the control unit 70.

The control unit 70 is electrically connected to the sensor apparatus 20, and is configured to calculate pressure that acts on each of the finger portions 3a and 3b and an in-plane distribution of the pressure, on the basis of output from the sensor apparatus 20. Further, on the basis of a temporal change in the above-described pressure and in-plane distribution of the pressure, the control unit 70 can detect a shearing force that acts on the pressure detection surface S. Furthermore, the control unit 70 is electrically connected to the controller 11, and, on the basis of a control instruction given by the controller 11, the control unit 70 outputs a grasping instruction to a drive unit 12a that drives the finger portions 3a and 3b of the hand portion 3.

### [Effects]

The sensor apparatus 20 of the present embodiment that has the configuration described above makes it possible to detect, with a high degree of accuracy, a distribution of stress that acts on the pressure detection surface S, since the surface layer 22 includes the internal layer portion 221 made of a flexible material. Further, the surface layer 22 includes the external layer portion 222 covering the internal layer portion 221, and the external layer portion 222 is made of a stretchable material having a higher elastic modulus than a material of the internal layer portion. This makes it possible to eliminate a distortion in the internal layer portion 221 concurrently with return of an elasticity of the external layer portion 222 while reducing a flowability of the internal layer portion 221 made of a flexible material. This makes it possible to enhance the conformability to a temporal change in a distribution of stress acting on the surface layer 22.

Further, the external layer portion 222 serves as a protection layer for the internal layer portion 221. For example, a distortion in the internal layer portion 221 that may be caused at a boundary between a contact region and a noncontact region of a grasped object on a surface of the surface layer 22 can be greatly reduced, compared to when there is no external layer portion 222. This makes it possible to improve a durability of the internal layer portion 221, and to also improve a durability of the sensor electrode layer 30 by reducing stress applied to the electrode layer 30 situated just under the boundary.

### Second Embodiment

FIG. 7 is a schematic cross-sectional side view of a sensor apparatus according to a second embodiment of the present technology. A sensor apparatus 230 of the present embodiment is different from the sensor apparatus of the above-described first embodiment in that a surface layer 22A includes the internal layer portion 221, the external layer portion 222 and an intermediate layer portion 223.

The intermediate layer portion 223 is arranged between the internal layer portion 221 and the external layer portion 222, and is made of a material, such as a plastic film or an elastomer sheet, that has a higher elastic modulus (that is less stretchable) than a material of the external layer portion 222. The present embodiment makes it possible to improve restoration properties of the internal layer portion 221 and thus to improve the durability for repeated loading, since the intermediate layer portion 223 is provided between the internal layer portion 221 and the external layer portion 222.

### Third Embodiment

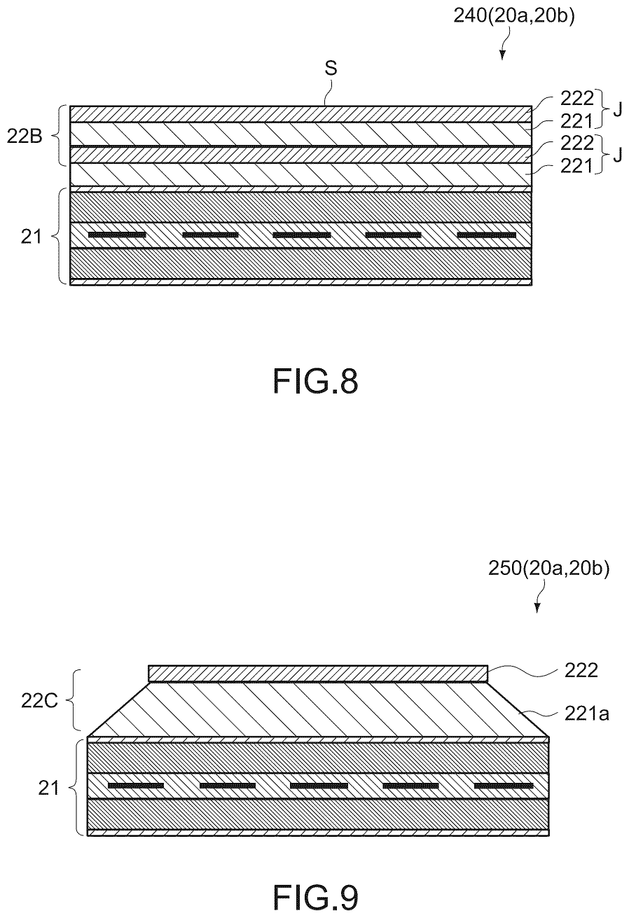

FIG. 8 is a schematic cross-sectional side view of a sensor apparatus according to a third embodiment of the present technology. A sensor apparatus 240 of the present embodiment is different from the sensor apparatus of the above-described first embodiment in that a surface layer 22B has a structure in which the internal layer portion 221 and the external layer portion 222 are alternately stacked multiple times. In the present embodiment, two laminates J each including a pair of the internal layer portion 221 and the external layer portion 222 are stacked. The internal layer portions 221 respectively included in the laminates J are made of the same material and have the same thickness, and the external layer portions 222 respectively included in the laminates J are made of the same material and have the same thickness.

According to the present embodiment, the surface layer 22C has a stacking structure including stacked laminates J. Thus, the surface layer 22C is less stiff in an in-plane direction of the surface layer 22C than in a thickness direction of the surface layer 22C, compared to a structure including a single laminate J. This makes it possible to improve the durability for stress applied in the thickness direction of the surface layer 22C while securing an accuracy in detecting an in-plane distribution of pressure on the surface layer 22C and a shearing force acting on the surface layer 22C. Such an action and effect can be more easily obtained as the number of laminates J stacked is increased.

### Fourth Embodiment

FIG. 9 schematically illustrates a configuration of a sensor apparatus 250 according to a fourth embodiment of the present technology. The sensor apparatus 250 of the present embodiment is different from the sensor apparatus of the above-described first embodiment in that an internal layer portion 221a that forms a surface layer 22C has a trapezoidal cross section in a thickness direction of the internal layer portion 221a.

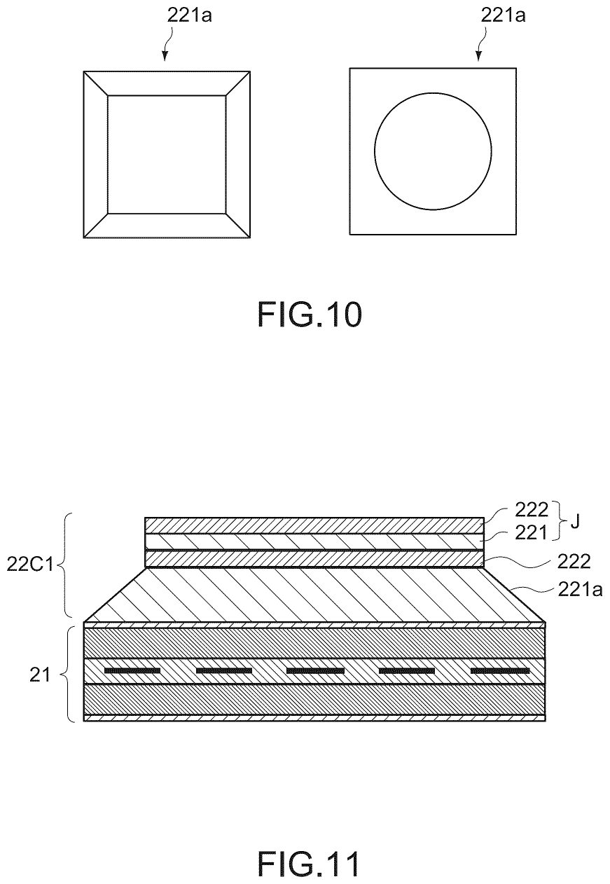

An upper surface of the internal layer portion 221a is formed to have a smaller area than a lower surface of the internal layer portion 221a. In the present embodiment, the area of the internal layer portion 221a is set to be smaller than a detection region of the sensor electrode layer 30. The shape of the upper surface of the internal layer portion 221a is not particularly limited, and the upper surface of the internal layer portion 221a may be rectangular, as illustrated on the left in FIG. 10, or may be circular, as illustrated on the right in FIG. 10. The external layer portion 222 is stacked on the upper surface of the internal layer portion 221a. The present embodiment makes it possible to detect a shearing force acting on the pressure detection surface S by forming the internal layer portion 221a into the shape described above, even if the area of contact with a grasped object is relatively large.

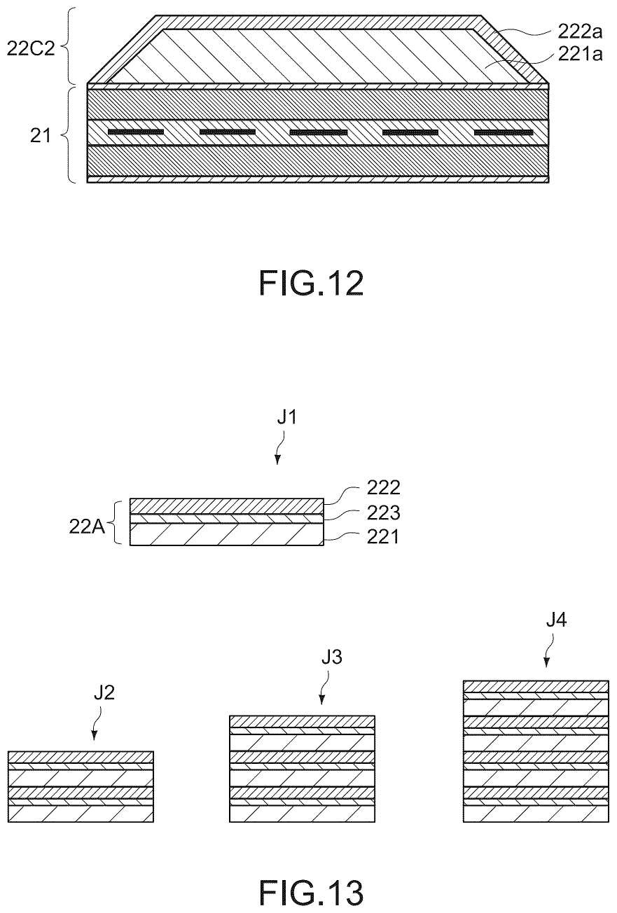

FIGS. 11 and 12 are schematic cross-sectional side views of modifications of the configuration of the surface layer 22C included in the sensor apparatus. A surface layer 22C1 illustrated in FIG. 10 is obtained by stacking another laminate J on the surface layer 22C illustrated in FIG. 9. This makes it possible to improve a durability of the surface layer 22C1.

On the other hand, a deformation layer 22C2 illustrated in FIG. 12 is different from the surface layer included in the sensor apparatus illustrated in FIG. 9 in that an external layer portion 222a covers not only an upper surface of an internal layer portion 221a but also an entire surface of the internal layer portion 221a that includes the upper surface. This makes it possible to obtain an action and effect similar to the action and effect described above, and to further improve a durability of the internal layer portion 222a. Further, the entire surface of the internal layer portion 221a is covered with the external layer portion 222a. This makes it possible to improve shape-returning properties of the internal layer portion 221a upon eliminating stress, and thus to improve the durability for repeated loading.

### Experimental Examples

As illustrated in FIG. 13, using, as a set of layer, a laminate J1 (corresponding to the surface layer 22A illustrated in FIG. 7) in which the internal layer portion 221 having a thickness of 1 mm, the intermediate layer portion 223 having a thickness of 0.1 mm, and the external layer portion 222 having a thickness of 0.5 mm are stacked in this order, a one-layer laminate J1, a two-layer laminate J2, a three-layer laminate J3, and four-layer laminate J4 were formed. The laminates J1 to J4 each had a planar shape of a square 24 mm on a side. For example, the internal layer portions 221 respectively included in the laminates J1 to J4 were made of the same material and had the same thickness, the intermediate layer portions 223 respectively included in the laminates J1 to J4 were made of the same material and had the same thickness, and the external layer portions 222 respectively included in the laminates J1 to J4 were made of the same material and had the same thickness.

Stiffness of each of the formed laminates J1 to J4 in a thickness direction (a Z direction) and a shearing stiffness of each of the laminates J1 to J4 in an in-plane direction (an XY direction) were measured under the respective conditions indicated below.

### (Measurement of Stiffness in Thickness Direction)

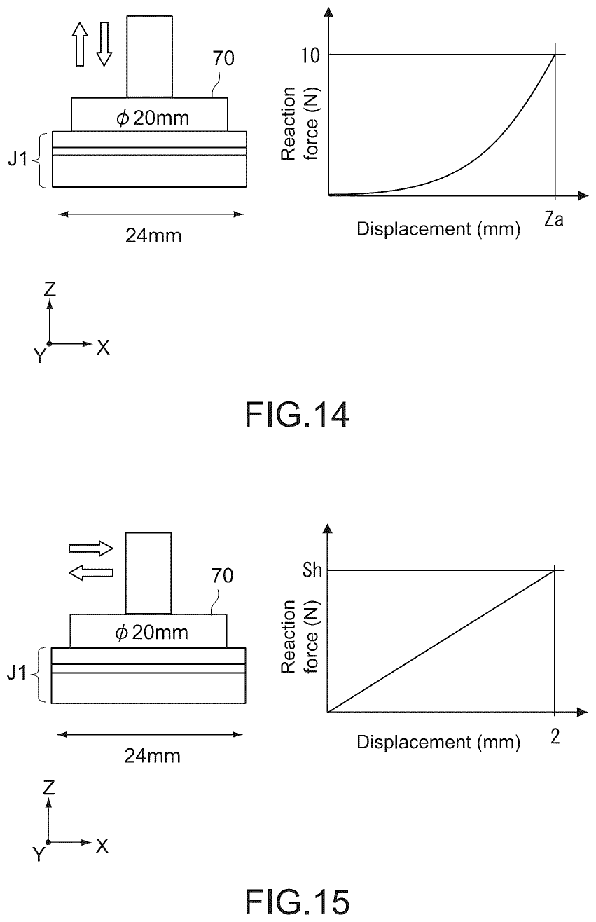

As illustrated in FIG. 14, a center portion of the laminate J1 was pressed using a pusher 70 having a diameter of 20 mm, and a displacement Za of the laminate J1 when a reaction force was 10 N was measured. Stiffness (the Young's modulus) in the Z direction was calculated on the basis of the measured displacement Za (reaction force/Za). With respect to the laminates J2 to J4, stiffness (the Young's modulus) of each of the laminates J2 to J4 in the Z direction was calculated by a method similar to the method described above.

### (Shearing Stiffness)

As illustrated in FIG. 15, the pusher 70 is moved horizontally in a state in which the center portion of the laminate J1 was pressed using the pusher 70 with pressure applied such that the reaction force is 10 N, and the reaction force when an amount of displacement of the laminate J1 was 2 mm was measured as a shearing force Sh. Stiffness (the Young's modulus) in the XY direction was calculated on the basis of the measured shearing force (Sh/displacement). With respect to the laminates J2 to J4, stiffness (the Young's modulus) of each of the laminates J2 to J4 in the XY direction was calculated by a method similar to the method described above.

Further, the laminates J1 and J2 each including the internal layer portion 221 having a thickness of 2 mm were formed, and stiffness of each of the laminates J1 and J2 in the Z direction and stiffness of each of the laminates J1 and J2 in the XY direction were calculated by methods similar to the methods described above.

Results of the calculations are given collectively in Table 1.

TABLE 1

| | | J1 | J2 | J3 | J4 | J1 | J2 |
|---|---|---|---|---|---|---|---|
| A | Total thickness of internal layer portion (mm) | 1 | 2 | 3 | 4 | 2 | 4 |
| B | Za(mm) | 0.09 | 0.11 | 0.13 | 0.18 | 0.2 | 0.35 |
| C | Stiffness in thickness direction (N/mm) | 111 | 91 | 77 | 56 | 50 | 29 |
| D | Stiffness per millimeter of thickness (N/mm) | 111 | 182 | 231 | 222 | 100 | 114 |
| E | Shearing force (N) | 5.37 | 2.31 | 1.66 | 1.22 | 2.93 | 1.53 |
| F | Stiffness in shearing direction (N/mm) | 2.685 | 1.155 | 0.83 | 0.61 | 1.465 | 0.765 |
| G | Shearing stiffness per millimeter of width (N/mm) | 64 | 28 | 20 | 15 | 35 | 18 |
| H | Stiffness anisotropy parameter 1 (C/F) | 41 | 79 | 93 | 91 | 34 | 37 |
| I | Stiffness anisotropy parameter 2 (D/G) | 2 | 7 | 12 | 15 | 3 | 6 |

As seen from Table 1, both a value of stiffness in the thickness direction (an item C) and a value of stiffness in the shearing direction (an item F) tend to become smaller as the number of the laminates J1 stacked is increased. Further, both the value of the stiffness in the thickness direction (the item C) and the value of the stiffness in the shearing direction (the item F) tend to become smaller as the thickness of the internal layer portion 221 is increased if the numbers of the laminates J1 stacked are the same.

Further, in Table 1, a stiffness anisotropy parameter 1 (an item H) is a ratio of the stiffness in the thickness direction (the item C) and the stiffness in the shearing direction (the item F), and a stiffness anisotropy parameter 2 (an item I) is a ratio of stiffness in the thickness direction per millimeter of thickness (an item D) and stiffness in the shearing direction per millimeter of width (an item G). It means that stiffness is greater in the thickness direction than in a plane direction if these parameters have larger values. Note that, with respect to each of the items D and G, conversion was performed to obtain stiffness per millimeter in order to evaluate all of the axes equally.

The above-described optimization of the number of the laminates J1 stacked and the elastic modulus of the internal layer portion 221 makes it possible to design a surface layer that is sufficiently flexible in the shearing direction and sufficiently stiff in the Z direction.

### Other Embodiments

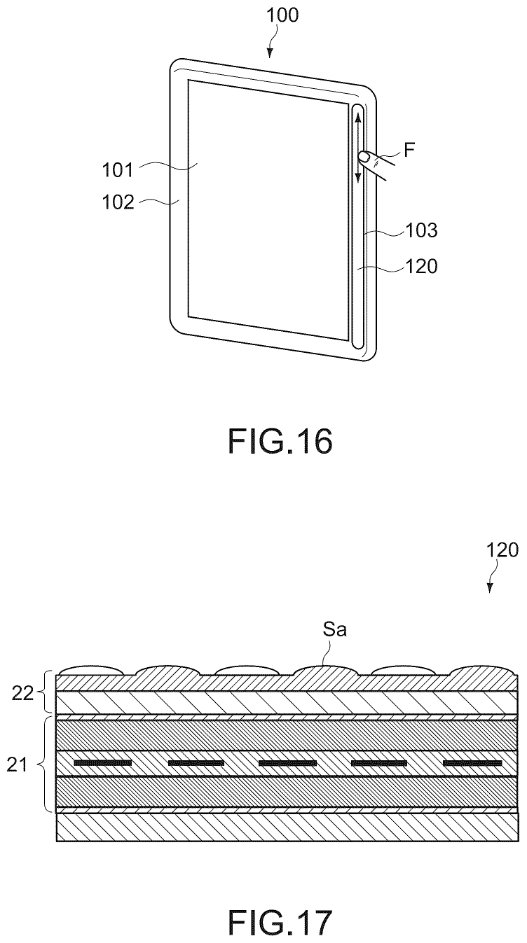

The example of applying the sensor apparatus 20 according to the present technology as a pressure distribution sensor provided to the hand portion 3 of the robotic apparatus 10 has been described in the respective embodiments above. Without being limited thereto, the sensor apparatus according to the present technology may also be applied to an input operation surface included in a user interface (UI) of an electronic apparatus. For example, the sensor apparatus according to the present technology can also be applied to a slate-type portable information terminal 100, such as a smartphone or a tablet personal computer (PC), that serves as the electronic apparatus, as illustrated in FIG. 16. In the portable information terminal 100, an input operation surface 103 is provided around a body 102 that includes a display section 101. The arrangement of a sensor apparatus 120 in the input operation surface 103 makes it possible to electrostatically detect a touch operation or movement operation performed with a finger F of a user.

In this case, a surface layer of the sensor apparatus 120 is not limited to being formed to have a flat surface, and the surface layer may have an uneven surface, as illustrated in, for example, FIG. 17. The figure illustrates an example in which protrusions Sa each having a partially spherical shape (a spherical-segment shape) are formed in the surface of the surface layer 22. Of course the shape of the protrusion Sa is not limited thereto, and the cross section of the protrusion Sa may have a discretionary shape such as a rectangle or a triangle. Such a shape of the surface of the surface layer 22 can also be applied to the respective embodiments described above.

In addition to the example described above, examples of the input operation surface of the electronic apparatus also include an operation button and an operation stick that are included in a controller for a game machine, as well as various operation sections of an image-capturing apparatus such as a digital camera.

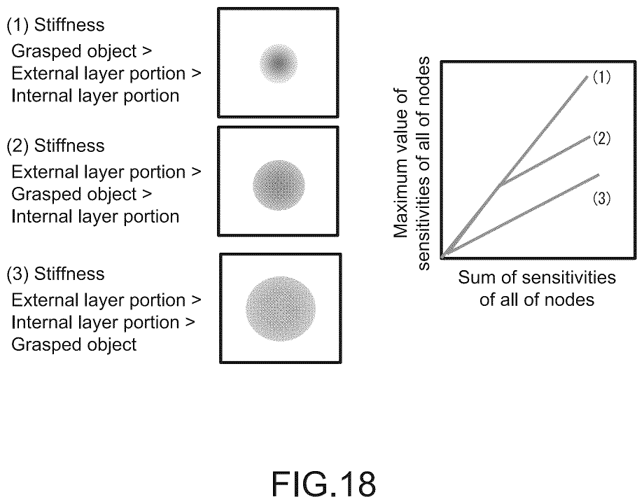

Further, the sensitivity detected by a pressure distribution sensor varies due to which of a grasped object and the surface layer 22 is stiffer. As illustrated in, for example, FIG. 18, when a grasped object is stiffer than the external layer portion 222 (the surface layer 22), the grasped object is not easily deformed, and the surface layer 22 is easily deformed. Thus, a pressure distribution region is small, and a maximum value of the sensitivities is large, as illustrated in (1). Conversely, when a grasped object is softer than the surface layer 22, the grasped object is easily deformed, and the surface layer 22 is not easily deformed. Thus, the pressure distribution region is large, and the maximum value of the sensitivities is small, as illustrated in (2) or (3). (2) in the figure illustrates the case in which the grasped object is stiffer than the internal layer portion 221, and (3) in the figure illustrates the case in which the grasped object is softer than the internal layer portion 222. When detection is performed by obtaining a relationship between a sum of sensitivities of all of nodes and a maximum of the sensitivities of all of the nodes (a slope), as described above, this makes it possible to detect whether a grasped object is stiffer or softer than the surface layer 22 or whether the grasped object is stiffer or softer than the internal layer portion 221. When such a relationship is obtained by computation or machine learning, this makes it possible to have a grasped object grasped with an appropriate grasping force even if the grasped object is unknown.

### <Modifications>

For example, a capacitance-change-type detection element is used to detect a pressure distribution in the embodiments described above. Without being limited thereto, for example, a resistance-change-type detection element in which a resistance value is changed according to a magnitude of pressure may be used.

Note that the present technology may also take the following configurations.

(1) A sensor apparatus, including:
a sensor section that is capable of detecting a pressure distribution; and
a surface layer that includes
   an internal layer portion that is arranged on the sensor section, the internal layer portion being made of a flexible material, and
   an external layer portion that covers the internal layer portion, the external layer portion being made of a deformable material that has a higher elastic modulus than the material of the internal layer portion.
      (2) The sensor apparatus according to (1), in which,
the sensor section includes
   a sensor electrode layer that includes a plurality of capacitive elements arranged in a matrix, and
   a deformation layer that is deformable to support the sensor electrode layer, the deformation layer being made of a material that has a lower elastic modulus than the material of the internal layer portion.
      (3) The sensor apparatus according to (2), in which
the surface layer further includes an intermediate layer portion that is arranged between the internal layer portion and the external layer portion, the intermediate layer portion being made of a material that has a higher elastic modulus than the material of the external layer portion.
   (4) The sensor apparatus according to (2) or (3), in which
the surface layer has a stacking structure in which the internal layer portion and the external layer portion are stacked alternately.
   (5) The sensor apparatus according to any one of (2) to (4), in which
the internal layer portion has a trapezoidal cross section parallel to a thickness direction of the internal layer portion.
   (6) The sensor apparatus according to any one of (2) to (5), in which
the internal layer portion is made of a flowable material or a rubber material.
   (7) The sensor apparatus according to any one of (2) to (6), in which
the external layer portion is made of a rubber material or an elastomer material.
   (8) The sensor apparatus according to any one of (2) to (7), in which
the sensor section further includes a reference electrode layer that is connected to a reference potential, and
the deformation layer is arranged between the sensor electrode layer and the reference electrode layer.
   (9) The sensor apparatus according to any one of (2) to (7), in which
the sensor section includes
   a pair of pressure sensors each including the sensor electrode layer, the deformation layer, and the reference electrode layer, and
   an isolation layer that is arranged between pressure sensors of the pair of pressure sensors, the isolation layer being made of a viscoelastic material.
      (10) A robotic apparatus, including:
a hand portion that includes a plurality of finger portions respectively including grasping surfaces with which a piece of work is graspable; and
sensor apparatuses that are respectively provided to the grasping surfaces,
the sensor apparatus including
   a sensor section that is capable of detecting a distribution of pressure acting on the grasping surface, and
   a surface layer that includes
      an internal layer portion that is arranged on the sensor section, the internal layer portion being made of a flexible material, and
      an external layer portion that covers the internal layer portion, the external layer portion being made of a material that has a higher elastic modulus than the material of the internal layer portion.
         (11) An electronic apparatus, including:
an input operation surface; and
a sensor apparatus that is provided to the input operation surface,
the sensor apparatus including
   a sensor section that is capable of detecting a distribution of pressure acting on the input operation surface, and
   a surface layer that includes
      an internal layer portion that is arranged on the sensor section, the internal layer portion being made of a flexible material, and
      an external layer portion that covers the internal layer portion, the external layer portion being made of a material that has a higher elastic modulus than the material of the internal layer portion.

### REFERENCE SIGNS LIST

10 robotic apparatus
20, 20A, 20B sensor apparatus
21, 21a, 21b pressure sensor
22, 22A, 22B, 22C1, 22C2 surface layer
23 isolation layer
25 reference electrode layer
27 deformation layer
30 sensor electrode layer
70 control unit
210 sensor sheet
221 internal layer portion
222 external layer portion
223 intermediate layer portion

1. A sensor apparatus, comprising:
a sensor section that is capable of detecting a pressure distribution; and
a surface layer that includes
an internal layer portion that is arranged on the sensor section, the internal layer portion being made of a flexible material, and
an external layer portion that covers the internal layer portion, the external layer portion being made of a deformable material that has a higher elastic modulus than the material of the internal layer portion.

2. The sensor apparatus according to claim 1, wherein,
the sensor section includes
a sensor electrode layer that includes a plurality of capacitive elements arranged in a matrix, and
a deformation layer that is deformable to support the sensor electrode layer, the deformation layer being made of a material that has a lower elastic modulus than the material of the internal layer portion.

3. The sensor apparatus according to claim 2, wherein
the surface layer further includes an intermediate layer portion that is arranged between the internal layer portion and the external layer portion, the intermediate layer portion being made of a material that has a higher elastic modulus than the material of the external layer portion.

4. The sensor apparatus according to claim 2, wherein
the surface layer has a stacking structure in which the internal layer portion and the external layer portion are stacked alternately.

5. The sensor apparatus according to claim 2, wherein
the internal layer portion has a trapezoidal cross section parallel to a thickness direction of the internal layer portion.

6. The sensor apparatus according to claim 2, wherein
the internal layer portion is made of a flowable material or a rubber material.

7. The sensor apparatus according to claim 2, wherein
the external layer portion is made of a rubber material or an elastomer material.

8. The sensor apparatus according to claim 2, wherein
the sensor section further includes a reference electrode layer that is connected to a reference potential, and
the deformation layer is arranged between the sensor electrode layer and the reference electrode layer.

9. The sensor apparatus according to claim 2, wherein
the sensor section includes
a pair of pressure sensors each including the sensor electrode layer, the deformation layer, and the reference electrode layer, and
an isolation layer that is arranged between pressure sensors of the pair of pressure sensors, the isolation layer being made of a viscoelastic material.

10. A robotic apparatus, comprising:
a hand portion that includes a plurality of finger portions respectively including grasping surfaces with which a piece of work is graspable; and
sensor apparatuses that are respectively provided to the grasping surfaces,
the sensor apparatus including
a sensor section that is capable of detecting a distribution of pressure acting on the grasping surface, and
a surface layer that includes
an internal layer portion that is arranged on the sensor section, the internal layer portion being made of a flexible material, and
an external layer portion that covers the internal layer portion, the external layer portion being made of a material that has a higher elastic modulus than the material of the internal layer portion.

11. An electronic apparatus, comprising:
an input operation surface; and
a sensor apparatus that is provided to the input operation surface,
the sensor apparatus including
a sensor section that is capable of detecting a distribution of pressure acting on the input operation surface, and
a surface layer that includes
an internal layer portion that is arranged on the sensor section, the internal layer portion being made of a flexible material, and
an external layer portion that covers the internal layer portion, the external layer portion being made of a material that has a higher elastic modulus than the material of the internal layer portion.
